(19) United States
(12) Patent Application Publication
(10) Pub. No.: US 2022/0002603 A1
(43) Pub. Date: Jan. 6, 2022

(54) ELASTOMER-DERIVED CERAMIC STRUCTURES AND USES THEREOF

(71) Applicant: 3M INNOVATIVE PROPERTIES COMPANY, St. Paul, MN (US)

(72) Inventors: Maiken Givot, St. Paul, MN (US); Brett A. Beiermann, St. Paul, MN (US)

(21) Appl. No.: 17/309,748

(22) PCT Filed: Dec. 17, 2019
(86) PCT No.: PCT/IB2019/060952

§ 371 Date: Jun. 17, 2021

Related U.S. Application Data
(60) Provisional application No. 62/780,955, filed on Dec. 18, 2018.

(51) Int. Cl. C09K 3/14; C04B 35/10; C04B 35/48; C04B 35/80; C04B 35/64; C04B 35/628; B24D 3/06; B33Y 10/00; B28B 1/00; B28B 11/24; B33Y 40/20

(52) U.S. Cl. CPC C09K 3/1436; B33Y 80/00; C04B 35/48; C04B 35/80; C04B 35/64; C04B 35/62844; B24D 3/06; B33Y 10/00; B28B 1/001; B28B 11/243; B33Y 40/20; C04B 2235/48; C04B 2235/3217; C04B 2235/3244; C04B 2235/3852; C04B 2235/3817; C04B 2235/5256; C04B 2235/6026; C04B 35/10

(57) ABSTRACT

The disclosure relates to, among other things, an abrasive article comprising a plurality of 4D-ceramic structures, wherein the 4D-ceramic structures are made by a method comprising sequentially: at least partially removing a strain from a second strained primary polymer ceramic precursor, comprising a polymeric substrate and ceramic precursor particles dispersed therein, to give a 4-D ceramic precursor comprising a polymeric substrate; and thermolytically removing the polymeric substrate from the 4-D ceramic precursor comprising a polymeric substrate to provide a 4D-ceramic structure.

### BACKGROUND

Four-dimensional (4D) printing involves conventional 3D printing followed by a shape-morphing step. It enables more complex shapes to be created than is possible with conventional 3D printing. However, 3D-printed ceramic precursors can be difficult to be deformed, hindering the development of 4D printing for ceramics, including ceramics that can be incorporated into abrasive articles.

### SUMMARY

Elastomeric matrix nanocomposites (NCs) that can be printed, deformed, and then transformed into oxycarbide matrix NCs can be used to solve such problems, making the growth of complex ceramic origami and 4D-printed ceramic structures possible. In addition, the printed ceramic precursors are deformable (e.g., can be stretched beyond three times their initial length). Hierarchical elastomer-derived ceramics (EDCs) can be achieved with programmable architectures spanning three orders of magnitude, from 200 μm to 10 cm. These architectures can be incorporated into the abrasive articles described herein.

### DESCRIPTION OF THE FIGURES

The drawings illustrate generally, by way of example, but not by way of limitation, various embodiments discussed in the present document.

FIG. 1 is a perspective view illustrating a method of forming a portion of at least one of a primary polymeric ceramic precursor, first strained primary polymer ceramic precursor, second strained primary polymer ceramic precursor, and 4-D ceramic precursor in accordance with an embodiment.

FIG. 2 includes a perspective view illustration of a primary polymeric ceramic precursor.

FIGS. 3A and 3B are flow diagrams of methods of forming a portion of at least one of a primary polymeric ceramic precursor, first strained primary polymer ceramic precursor, second strained primary polymer ceramic precursor, and 4-D ceramic precursor in accordance with an embodiment.

FIGS. 3C-3E include a perspective view illustration of the various shapes of the 4-D ceramic precursors and 4-D ceramics that can be accessed via the methods described herein.

FIG. 3F is a plot of x- and y-axis strain and perspective view illustration of the various shapes of the 4-D ceramic precursors and 4-D ceramics that can be accessed via the methods described herein.

FIG. 3G is a perspective view illustration of the various shapes of the 4-D ceramic precursors and 4-D ceramics that can be accessed via the methods described herein.

FIG. 4 includes a cross-sectional illustration of a portion of a coated abrasive article according to an embodiment.

It should be understood that numerous other modifications and examples can be devised by those skilled in the art, which fall within the scope and spirit of the principles of the disclosure. Figures may not be drawn to scale.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, “bottom”, “upper”, “lower”, “under”, “over”, “front”, “back”, “up” and “down”, and “first” and “second” may be used in this disclosure, it should be understood that those terms are used in their relative sense only unless otherwise noted.

### DESCRIPTION

The following is generally directed to a method of forming 4D-printed ceramic structures utilizing an additive manufacturing process and abrasive articles comprising the same. The ceramic structures can be used in a variety of industries including, but not limited to, automotive, medical, construction, foundry, aerospace, and the like. Such ceramic structures can be utilized as free ceramics or incorporated into fixed abrasive articles including, for example, coated abrasive articles, bonded abrasive articles, non-woven abrasive article, and the like. Various other uses can be devised for the ceramics described herein.

The disclosure, therefore, relates to an abrasive article comprising a plurality of 4D-ceramic structures, wherein the 4D-ceramic structures are made by a method comprising sequentially:

at least partially removing a strain from a second strained primary polymer ceramic precursor, the second strained primary polymer ceramic precursor comprising a polymeric substrate and ceramic precursor particles dispersed therein, to give a 4-D ceramic precursor comprising a polymeric substrate; and

thermolytically removing (e.g., partially or substantially all) the polymeric substrate from the 4-D ceramic precursor comprising a polymeric substrate to provide a 4D-ceramic structure.

The disclosure also relates to an abrasive article comprising a plurality of 4D-ceramic structures, wherein the 4D-ceramic structures are made by a method comprising sequentially:

providing a primary polymeric ceramic precursor, the primary polymer ceramic precursor comprising a polymeric substrate and ceramic precursor particles dispersed therein, the primary polymeric ceramic precursor comprising first and second portions;

straining the primary polymeric ceramic precursor to give a first strained primary polymer ceramic precursor comprising a polymeric substrate;

additively manufacturing at least one third portion on the first strained primary polymeric ceramic precursor to give a second strained primary polymer ceramic precursor comprising a polymeric substrate;

at least partially removing a strain from the second strained primary polymer ceramic precursor to give a 4-D ceramic precursor comprising a polymeric substrate; and

thermolytically removing the polymeric substrate from the 4-D ceramic precursor to provide a 4D-ceramic structure.

As used herein, an “additive manufacturing process” and “additively manufacturing” includes a process, wherein at least one of a primary polymeric ceramic precursor, first strained primary polymer ceramic precursor, second strained primary polymer ceramic precursor, and 4-D ceramic precursor can be formed by compiling a plurality of portions together in a particular orientation with respect to each other such that, when the plurality is compiled, each of the discrete portions can define at least a portion of the at least one of a primary polymeric ceramic precursor, first strained primary polymer ceramic precursor, second strained primary polymer ceramic precursor, and 4-D ceramic precursor. Moreover, in particular instances, the additive manufacturing process can be a template-free process, wherein the material being manipulated to form discrete portions, and ultimately the at least one of a primary polymeric ceramic precursor, first strained primary polymer ceramic precursor, second strained primary polymer ceramic precursor, and 4-D ceramic precursor, need not be placed within a template (e.g., a mold). Rather, the material being manipulated can be deposited in discrete portions, wherein each of the discrete portions has a controlled dimension such that when the plurality is compiled, the at least one of a primary polymeric ceramic precursor, first strained primary polymer ceramic precursor, second strained primary polymer ceramic precursor, and 4-D ceramic precursor also has a controlled dimension. Therefore, unlike typical molding operations, additive manufacturing processes of the embodiments herein may not necessarily need to incorporate a template that is configured to contain the material being manipulated to form the at least one of a primary polymeric ceramic precursor, first strained primary polymer ceramic precursor, second strained primary polymer ceramic precursor, and 4-D ceramic precursor.

In particular instances, an additive manufacturing process that is used to form the at least one of a primary polymeric ceramic precursor, first strained primary polymer ceramic precursor, second strained primary polymer ceramic precursor, and 4-D ceramic precursor can be a prototype printing process. In more particular instances, the process of forming the at least one of a primary polymeric ceramic precursor, first strained primary polymer ceramic precursor, second strained primary polymer ceramic precursor, and 4-D ceramic precursor can include a prototype printing/additively manufacturing of one or more portions of the at least one of a primary polymeric ceramic precursor, first strained primary polymer ceramic precursor, second strained primary polymer ceramic precursor, and 4-D ceramic precursor, where the at least one of a primary polymeric ceramic precursor, first strained primary polymer ceramic precursor, second strained primary polymer ceramic precursor, and 4-D ceramic precursor includes a primary polymeric ceramic precursor. In other instances, the additive manufacturing process can include or be considered a laminated object manufacturing process. In the laminated object manufacturing process, individual layers can be formed discretely and joined together to form the at least one of a primary polymeric ceramic precursor, first strained primary polymer ceramic precursor, second strained primary polymer ceramic precursor, and 4-D ceramic precursor.

The at least one of a primary polymeric ceramic precursor, first strained primary polymer ceramic precursor, second strained primary polymer ceramic precursor, and 4-D ceramic precursor can be a mixture and can have a particular content of an inorganic material, which can be a solid powder material or particulate, such as a ceramic powder material comprising ceramic precursor particles. The ceramic precursor particles can have any suitable dimension. For example, the ceramic precursor particles can be ceramic precursor nanoparticles. “Nanoparticles” generally refers to a nanomaterial any suitable morphology including substantially spherical. But the nanoparticles can also have an irregular or substantially amorphous shape. In some examples, that include a plurality of nanoparticles, a major portion of the individual nanoparticles can be substantially spherical. For example, approximately 80% to about 100% of the nanoparticles can have a substantially spherical morphology.

A particle size of the individual nanoparticle is in a range of from about 20 nm to about 200 nm, about 40 nm to about 60 nm, or less than, equal to, or greater than about 20 nm, 30, 40, 50, 60, 70, 80, 90, 100, 110, 120, 130, 140, 150, 160, 170, 180, 190, or about 200 nm, such as a diameter from about or less than about 1 nm to about or greater than about 250 nm.

The “particle size” of the individual nanoparticle refers to the largest dimension of the nanoparticle. For example, the largest dimension of the nanoparticle can refer to a diameter, width, or height of the nanoparticle. In some examples including a plurality the nanoparticles, a first nanoparticle can have a particle size in a largest dimension that is different from a particle size in a largest dimension of a second nanoparticle.

The print material (e.g., the material that makes up the at least one of a primary polymeric ceramic precursor, first strained primary polymer ceramic precursor, second strained primary polymer ceramic precursor, and 4-D ceramic precursor) can include a mixture including an inorganic material having suitable rheological characteristics that facilitate formation of the primary polymeric ceramic precursor by an additive manufacturing process. For example, the at least one of a primary polymeric ceramic precursor, first strained primary polymer ceramic precursor, second strained primary polymer ceramic precursor, and 4-D ceramic precursor can have a solids content of at least about 25 wt. %, such as at least about 35 wt. %, at least about 36 wt. %, or even at least about 38 wt. % for the total weight of the mixture. Still, in at least one non-limiting example, the solids content of the at least one of a primary polymeric ceramic precursor, first strained primary polymer ceramic precursor, second strained primary polymer ceramic precursor, and 4-D ceramic precursor can be not greater than about 75 wt. %, such as not greater than about 70 wt. %, not greater than about 65 wt. %, not greater than about 55 wt. %, not greater than about 45 wt. %, not greater than about 44 wt. %, or not greater than about 42 wt. %. It will be appreciated that the content of the solids materials in the at least one of a primary polymeric ceramic precursor, first strained primary polymer ceramic precursor, second strained primary polymer ceramic precursor, and 4-D ceramic precursor can be within a range between any of the minimum and maximum percentages noted above, including for example within a range of at least about 25 wt. % and not greater than about 70 wt. %, the least about 35 wt. % and not greater than about 55 wt. %, or even at least about 36 wt. % and not greater than about 45 wt. %.

A ceramic powder material can include an oxide, a nitride, a carbide, a boride, an oxycarbide, an oxynitride particles, and a combination thereof. In particular instances, the ceramic material can include alumina or zirconia. More specifically, the ceramic material can include a boehmite material, which can be a precursor of alpha alumina. The term “boehmite” is generally used herein to denote alumina hydrates including mineral boehmite, typically being Al₂O₃.H₂O and having a water content on the order of 15%, as well as pseudoboehmite, having a water content higher than 15%, such as 20-38% by weight. It is noted that boehmite (including pseudoboehmite) has a particular and identifiable crystal structure, and therefore a unique X-ray diffraction pattern. As such, boehmite is distinguished from other aluminous materials including other hydrated aluminas such as ATH (aluminum trihydroxide), a common precursor material used herein for the fabrication of boehmite particulate materials.

Furthermore, the at least one of a primary polymeric ceramic precursor, first strained primary polymer ceramic precursor, second strained primary polymer ceramic precursor, and 4-D ceramic precursor can be in the form of a mixture comprising a content of liquid material comprising an elastomeric material, which forms the polymeric substrate in which the inorganic material can be dispersed, that can cured (e.g., by free-radical curing, metal-catalyzed curing, moisture curing, and photochemically curing), or at least B-staged (e.g., by heating to remove a solvent, such as an organic solvent). And if the primary polymeric ceramic precursor is B-staged it can be subsequently be cured. In some instances, the liquid is made entirely of an elastomeric material. But the liquid material can, in some instances, comprise another liquid (e.g., an organic solvent) that can be used to, among other things, adjust the rheology (e.g., viscosity) of the liquid material so as to facilitate formation of the at least one of a primary polymeric ceramic precursor, first strained primary polymer ceramic precursor, second strained primary polymer ceramic precursor, and 4-D ceramic precursor by an additive manufacturing process. Suitable elastomeric materials include polysiloxanes (e.g., PDMS), styrenic block copolymers, polyolefin elastomers, polyurethanes, copolyester, polyamides, and mixtures thereof.

To facilitate processing and forming the at least one of a primary polymeric ceramic precursor, first strained primary polymer ceramic precursor, second strained primary polymer ceramic precursor, and 4-D ceramic precursor according to embodiments herein, the at least one of a primary polymeric ceramic precursor, first strained primary polymer ceramic precursor, second strained primary polymer ceramic precursor, and 4-D ceramic precursor, can have a particular storage modulus. For example, the primary polymeric ceramic precursor can have a storage modulus of at least about 1×10⁴ Pa, such as at least about 4×10⁴ Pa, or even at least about 5×10⁴ Pa. However, in at least one non-limiting embodiment, the at least one of a primary polymeric ceramic precursor, first strained primary polymer ceramic precursor, second strained primary polymer ceramic precursor, and 4-D ceramic precursor can have a storage modulus of not greater than about 1×10⁷ Pa, such as not greater than about 2×10⁶ Pa. It will be appreciated that the storage modulus of the at least one of a primary polymeric ceramic precursor, first strained primary polymer ceramic precursor, second strained primary polymer ceramic precursor, and 4-D ceramic precursor can be within a range between any of the minimum and maximum values noted above. The storage modulus can be measured via any suitable method known in the art, including a parallel plate system using ARES or AR-G2 rotational rheometers, with Peltier plate temperature control systems.

The at least one of a primary polymeric ceramic precursor, first strained primary polymer ceramic precursor, second strained primary polymer ceramic precursor, and 4-D ceramic precursor can be formed to have a particular viscosity. For example, the mixture that forms the at least one of a primary polymeric ceramic precursor, first strained primary polymer ceramic precursor, second strained primary polymer ceramic precursor, and 4-D ceramic precursor can have a viscosity of at least about 4×10³ Pa s, such as at least about 5×10³ Pa s, at least about 6×10³ Pa s, at least about 7×10³ Pa s, at least about 7.5×10³ Pa s. In another non-limiting embodiment, the mixture can have a viscosity of not greater than about 20×10³ Pa s, such as not greater than about 18×10³ Pa s, not greater than about 15×10³ Pa s, not greater than about 12×10³ Pa s. Still, it will be appreciated that the mixture can have a viscosity within a range including any of the minimum and maximum values noted herein, including but not limited to, at least about 4×10³ Pa s and not greater than about 20×10³ Pa s, such as at least about 5×10³ Pa s and not greater than about 18×10³ Pa s, at least about 6×10³ Pa s and not greater than about 15×10³ Pa s. The viscosity can be measured in the same manner as the storage modulus as described herein.

Moreover, the at least one of a primary polymeric ceramic precursor, first strained primary polymer ceramic precursor, second strained primary polymer ceramic precursor, and 4-D ceramic precursor can be formed to have a particular content of organic materials including, for example, organic additives that can be distinct from the liquid to facilitate processing and formation of primary polymeric ceramic precursors according to the embodiments herein. Some suitable organic additives can include stabilizers, binders, UV curable resins, and the like, and combinations thereof.

FIG. 1A includes a perspective view illustration of a process of forming the at least one of a primary polymeric ceramic precursor, first strained primary polymer ceramic precursor, second strained primary polymer ceramic precursor, and 4-D ceramic precursor via an additive manufacturing process. As illustrated, the additive manufacturing process can utilize a deposition assembly 151 configured to have multi-axial movement in at least the X-direction, the Y-direction, and Z-direction for controlled deposition of a print material 122. In particular instances, the deposition assembly 151 can have a deposition head 153 configured to provide controlled delivery of the print material 122 to a particular position. Notably, the deposition assembly 151 can provide controlled deposition of a print material as a first portion at a first time and deposition of a second print material as a second portion that is distinct from the first portion at the second time. Such a process can facilitate the controlled deposition of discrete portions such that the discrete portions are deposited in precise locations with respect to each other and can facilitate formation of the at least one of a primary polymeric ceramic precursor, first strained primary polymer ceramic precursor, second strained primary polymer ceramic precursor, and 4-D ceramic precursor having suitable shape and dimensions.

In particular instances, the deposition assembly 151 can be configured to deposit a first composition 102 as a first portion 101. The first composition 102 can include a solid, a solution, a mixture, a liquid, a slurry, a gel, a binder, and a combination thereof. For example, the first composition 102 can include a sol gel material.

The first portion 101 can define a fraction of the total volume of the body of the primary polymeric ceramic precursor. In particular instances, the first portion 101 can have a first portion length (Lfp), a first portion width (Wfp), and a first portion thickness (Tfp). According to one embodiment, Lfp can be greater than or equal to Wfp, Lfp can be greater than or equal to Tfp, and Wfp can be greater than or equal to Tfp. In particular instances, the length of the first portion may define the largest dimension of the first portion 101, and the width of the first portion 101 may define a dimension extending in a direction generally perpendicular to the length (Lfp) and may define the second largest dimension of the first portion 101. Moreover, in some embodiments, the thickness (Tfp) of the first portion 101 may define the smallest dimension of the first portion 101 and may define a dimension extending in a direction perpendicular to either or both of the length (Lfp) and the width (Wfp). It will be appreciated, however, that the first portion 101 can have various shapes as will be defined further herein.

In accordance with an embodiment, the first portion 101 can have a primary aspect ratio (Lfp:Wfp) to facilitate suitable forming of the primary polymeric ceramic precursor. For example, the first portion 101 can have a primary aspect ratio (Lfp:Wfp) of at least about 1:1. In other embodiments, the first portion 101 can have a primary aspect ratio that is about 2:1, such as at least about 3:1, at least about 5:1, or even at least about 10:1. Still, in one non-limiting embodiment, the first portion 101 can have a primary aspect ratio of not greater than about 1000:1.

The first portion 101 of the primary polymeric ceramic precursor can have any suitable dimensions. Any of the foregoing dimensions (e.g., Lfp, Wfp, Tfp) of the first portion 101 can have an average dimension of not greater than about 2 mm. In other instances, the average dimension of any one of the first portion length (Lfp), first portion width (Wfp), or first portion thickness (Tfp) can have an average dimension of not greater than about 1 mm, such as not greater than about 900 microns, not greater than about 800 microns, not great than about 700 microns, not greater than about 600 microns, not greater than about 500 microns, not greater than about 400 microns, not greater than about 300 microns, not greater than about 200 microns, not greater than about 150 microns, not greater than about 140 microns, not greater than about 130 microns, not greater than about 120 microns, not greater than about 110 microns, not greater than about 100 microns, not greater than about 90 microns, not greater than about 80 microns, not greater than about 70 microns, not greater than about 60 microns, or even not greater than about 50 microns. Still, in another non-limiting embodiment, any one of the first portion length (Lfp), the first portion width (Wfp), or the first portion thickness (Tfp) can have an average dimension that is at least about 0.01 microns, such as at least about 0.1 microns, or even at least about 1 micron. It will be appreciated that any one of the first portion length, first portion width, or first portion thickness can have an average dimension within a range between any of the minimum and maximum values noted above.

In another embodiment, the first portion 101 can be deposited to have a particular cross-sectional shape. Deposition of the first portion 101 with a particular cross-sectional shape can facilitate formation of the primary polymeric ceramic precursor having a particular, desirable cross-sectional shape, three-, and four-dimensional shape. In accordance with an embodiment, the first portion 101 can have substantially any contemplated cross-sectional shape. More particularly, the first portion 101 can have a cross-sectional shape in a plane defined by the first portion length (Lfp) and first portion width (Wfp), such as triangular, quadrilateral, rectangular, trapezoidal, pentagonal, hexagonal, heptagonal, octagonal, ellipsoids, irregular shaped contours, and any combination thereof. Furthermore, the first portion 101 can be formed to have a particular cross-sectional shape in a plane defined by the first portion length (Lfp) and first portion thickness (Tfp). Such cross-sectional shape can include a shape selected from the group of triangular, quadrilateral, rectangular, trapezoidal, pentagonal, hexagonal, heptagonal, octagonal, ellipsoids, irregular shaped contours, and any combination thereof.

As further illustrated in FIG. 1A, the process of forming a primary polymeric ceramic precursor according to an additive manufacturing process also can include controlled deposition of a second portion 110 including a second composition 112. In an embodiment, the second composition 112 can include a solid, a solution, a mixture, a liquid, a slurry, a gel, a binder, and a combination thereof. In a particular embodiment, the second composition 112 can be the same as, or different from, the first composition. For example, the second composition 112 can include a sol gel material as described above. The deposition assembly 151 can deposit the second portion 110 in any suitable location including a particular location relative to the first portion 101. For example, as illustrated in FIG. 1A, the second portion 110 can be deposited in a position to abut at least a portion of the first portion 101. Such controlled multi-axial movement of the deposition assembly 151 can facilitate both precise deposition of discrete portions including, for example, the first portion 101 and the second portion 110, as well as controlled and precise deposition of a plurality of portions (and sub-portions) with respect to each other, thus facilitating the compilation of a plurality of portions to form the primary polymeric ceramic precursor.

As illustrated, the deposition assembly 151 can be configured to deposit the second composition 112 as the second portion 110 of the primary polymeric ceramic precursor. In particular, the second portion 110 can define a fraction of the total volume of the primary polymeric ceramic precursor. In particular instances, the second portion 110 can have a second portion length (Lsp), a second portion width (Wsp), and a second portion thickness (Tsp). Notably, according to one aspect, Lsp can be greater than or equal to Wsp, Lsp can be greater than or equal to Tsp, and Wsp can be greater than or equal to Tsp. In particular instances, the length (Lsp) of the second portion 110 may define the largest dimension of the second portion 110, and the width (Wsp) of the second portion 110 may define a dimension extending in a direction generally perpendicular to the length (Lsp) and may define the second largest dimension in accordance with an embodiment. Finally, in some embodiments, the thickness (Tsp) of the second portion 110 may define generally the smallest dimension of the second portion 110 and may define a dimension extending in a direction perpendicular to either or both of the length (Lsp) and the width (Wsp). It will be appreciated, however, that the second portion 110 can have various shapes as will be defined further herein.

In accordance with an embodiment, the second portion 110 can have a primary aspect ratio (Lsp:Wsp) that can facilitate formation of a primary polymeric ceramic precursor having a suitable shape and dimensions. For example, the second portion 110 can have a primary aspect ratio (Lsp:Wsp) of at least about 1:1. In other embodiments, the second portion 110 can have a primary aspect ratio that is about 2:1, such as at least about 3:1, at least about 5:1, or even at least about 10:1. Still, in one non-limiting embodiment, the second portion 110 can have a primary aspect ratio of not greater than about 1000:1.

The second portion 110 of the primary polymeric ceramic precursor can have any suitable dimensions. Any of the foregoing dimensions (e.g., Lsp, Wsp, Tsp) of the second portion 110 can have an average dimension of not greater than about 2 mm. In other instances, the average dimension of any one of the second portion length (Lsp), second portion width (Wsp), or second portion thickness (Tsp) can have an average dimension of not greater than about 1 mm, such as not greater than about 900 microns, not greater than about 800 microns, not great than about 700 microns, not greater than about 600 microns, not greater than about 500 microns, not greater than about 400 microns, not greater than about 300 microns, not greater than about 200 microns, not greater than about 150 microns, not greater than about 140 microns, not greater than about 130 microns, not greater than about 120 microns, not greater than about 110 microns, not greater than about 100 microns, not greater than about 90 microns, not greater than about 80 microns, not greater than about 70 microns, not greater than about 60 microns, or even not greater than about 50 microns. Still, in another non-limiting embodiment, any one of the second portion length (Lsp), the second portion width (Wsp), or the second portion thickness (Tsp) can have an average dimension that is at least about 0.01 microns, such as at least about 0.1 microns, or even at least about 1 micron. It will be appreciated that any one of the second portion length, second portion width, or second portion thickness can have an average dimension within a range between any of the minimum and maximum values noted above.

In another embodiment, the second portion 110 can be deposited to have a particular cross-sectional shape. Deposition of the second portion 110 with a particular cross-sectional shape can facilitate formation of a primary polymeric ceramic precursor having a particular, desirable cross-sectional shape and three-dimensional shape. In accordance with an embodiment, the second portion 110 can have substantially any contemplated cross-sectional shape. More particularly, the second portion 110 can have a cross-sectional shape in a plane defined by the second portion length (Lsp) and second portion width (Wsp), which can be viewed top-down, where the shape is selected from the group of triangular, quadrilateral, rectangular, trapezoidal, pentagonal, hexagonal, heptagonal, octagonal, ellipsoids, complex polygonal shapes, irregular shaped contours, and any combination thereof. Furthermore, the second portion 110 can be formed to have a particular cross-sectional shape in a plane defined by the second portion length (Lsp) and second portion thickness (Tsp), which can be evident in a side-view. Such cross-sectional shape can include a shape selected from the group of triangular, quadrilateral, rectangular, trapezoidal, pentagonal, hexagonal, heptagonal, octagonal, ellipsoids, complex polygonal shapes, irregular shaped contours, and any combination thereof.

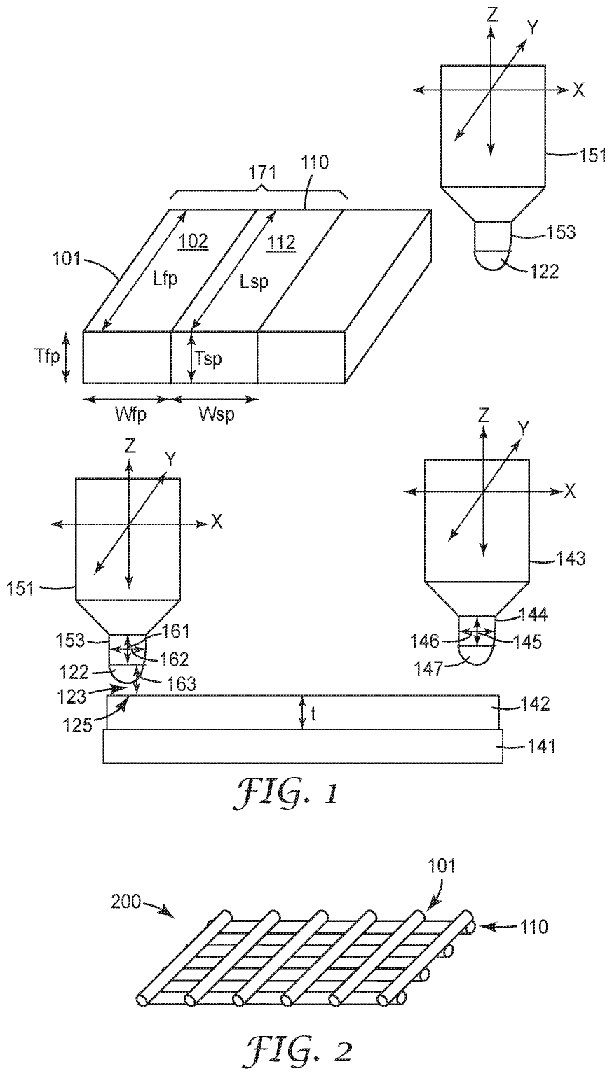

In some instances, the first portion 101 and second portion 110 can be deposited in a substantially orthogonal fashion as shown in FIG. 2 to give primary polymeric ceramic precursor 200, in this case substantially in the form of a lattice. But it should be understood that the second portion 110 can be deposited at angles greater than 90° or less than 90°, relative to the first portion. In this example, the cross-sectional shape of the first portion 101 is circular and is the same as that of the cross-sectional shape of the second portion 110. But as explained herein, the cross-section shape of the first portion 101 can be different from the cross-sectional shape of the second portion 110.

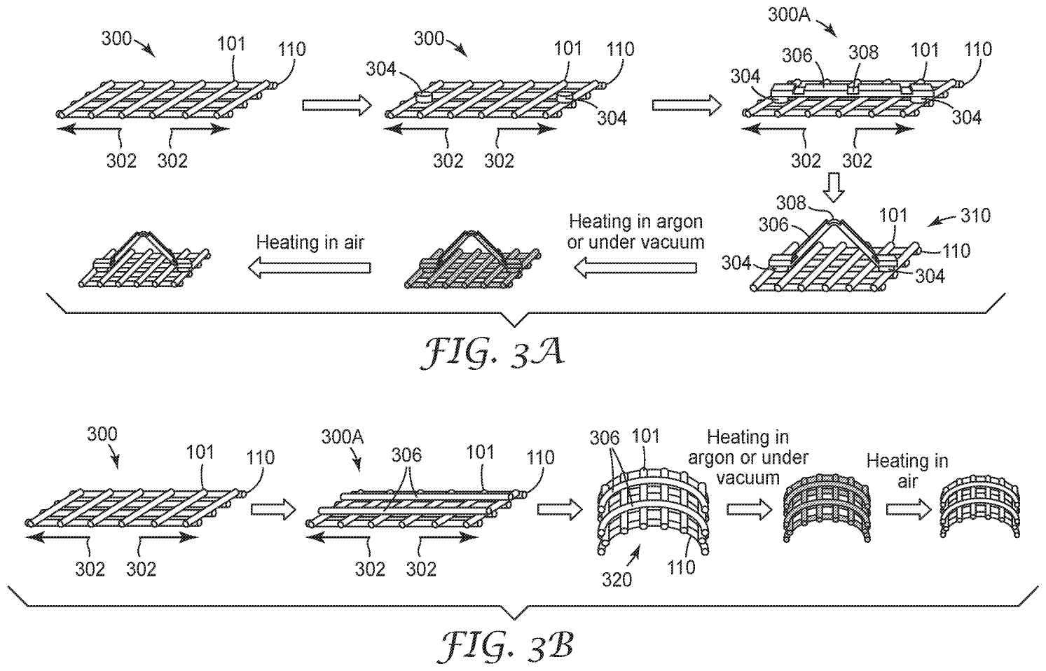

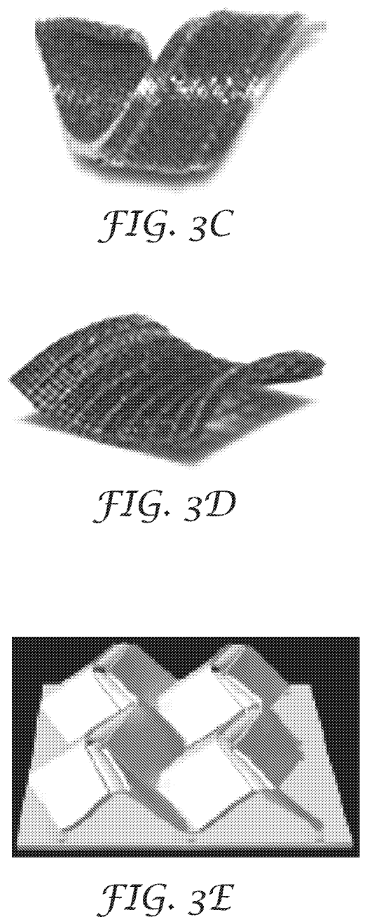

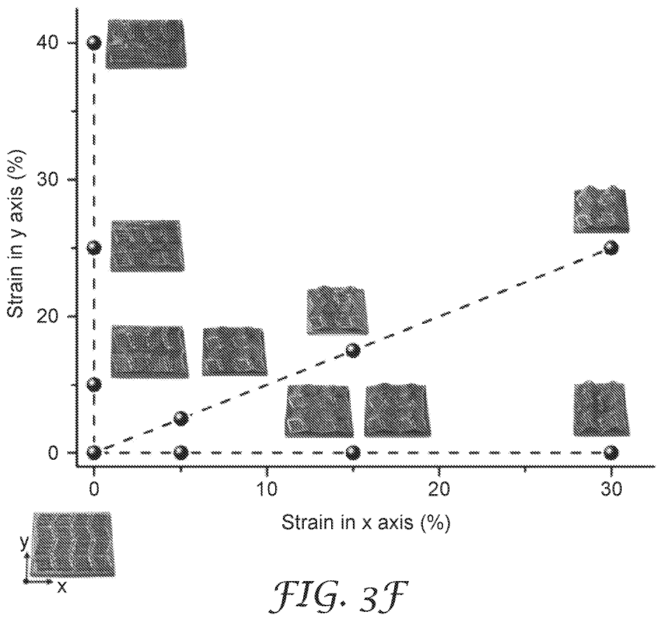

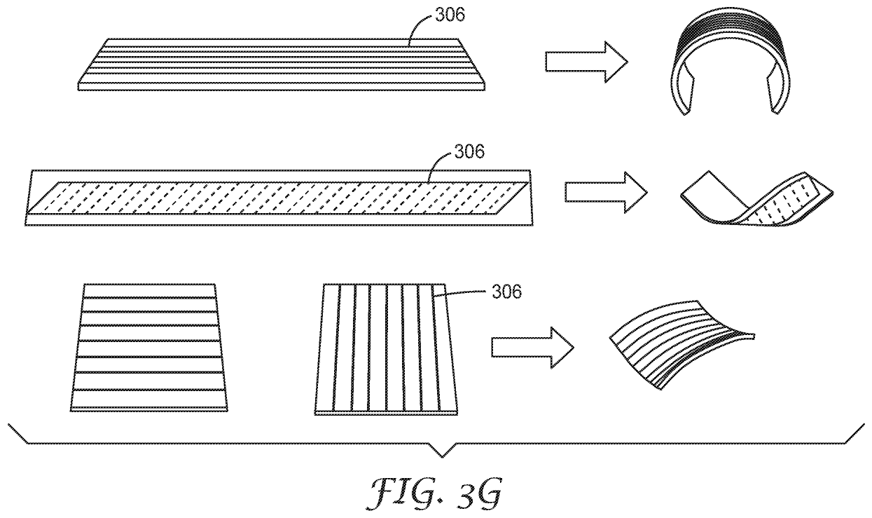

As further illustrated in FIG. 3A, the process of forming a primary polymeric ceramic precursor according to an additive manufacturing process also can include straining (e.g., deforming by at least one of bending, twisting, and stretching) the primary polymeric ceramic precursor comprising a polymeric substrate shown in FIG. 2 to give a first strained primary polymeric ceramic precursor 300, where the strain can be a longitudinal strain, such as by stretching in one or more directions. In FIG. 3A, the primary polymeric ceramic precursor 200 has been strained by stretching in a single direction, along the x-axis, as shown by the opposing arrows 302, to form the first strained primary polymeric ceramic precursor 300. But the primary polymeric ceramic precursor 200 can be strained along the x-axis and along the y-axis, simultaneously, though the strain in each directional axis need not be the same. Indeed, the straining in an x-axis can be different than the straining in a y-axis. But in some instances, the straining in an x-axis is substantially the same as the straining in a y-axis.

As further illustrated in FIG. 3A, the additive manufacturing process can also include controlled deposition of a third portion 306 on the first strained primary polymeric ceramic precursor 300 to give a second strained primary polymeric ceramic precursor 300A, comprising a feature that can become a creasing point 308, and a fourth portion 304 serving as the anchor point for the third portion 306, the third portion 306 being attached to at least one of the first portion 101 and the second portion 110, only at fourth portion 304. In this example, the third portion 306 is deposited in a substantially orthogonal fashion to the first portion 101. But it should be understood that the third portion 306 can be deposited at angles greater than 90° or less than 90°, relative to the first portion. It should be understood that for there to be an angle greater than or less than 90°, relative to the first portion, the anchor point would be moved coaxially with the first portion 101 to create the angle relative to the first portion 101.

As further illustrated in FIG. 3A, the additive manufacturing process can also include at least partially destraining the second strained primary polymer ceramic precursor 300A to give an at least a partially destrained second primary polymer ceramic precursor 310, also referred to herein as a 4-D ceramic precursor, comprising at least one three-dimensional feature, such as the one formed by the third portion 306, upon release of the strain along the x-axis.

As further illustrated in FIG. 3B, the process of forming a primary polymeric ceramic precursor according to an additive manufacturing process also can include straining (e.g., deforming by at least one of bending, twisting, and stretching) the primary polymeric ceramic precursor comprising a polymeric substrate shown in FIG. 2 to give a first strained primary polymeric ceramic precursor 300, where the strain can be a longitudinal strain, such as by stretching in one or more directions. In FIG. 3A, the primary polymeric ceramic precursor 200 has been strained by stretching in a single direction, along the x-axis, as shown by the opposing arrows 302, to form the first strained primary polymeric ceramic precursor 300. But the primary polymeric ceramic precursor 200 can be strained along the x-axis and along the y-axis, simultaneously, though the strain in each directional axis need not be the same. Indeed, the straining in an x-axis can be different than the straining in a y-axis. But in some instances, the straining in an x-axis is substantially the same as the straining in a y-axis.

As further illustrated in FIG. 3B, the additive manufacturing process can also include controlled deposition of at least one third portion 306 on first strained primary polymeric ceramic precursor 300 to give the second primary polymer ceramic precursor 300A.

As further illustrated in FIG. 3B, the additive manufacturing process can also include at least partially destraining the second primary polymer ceramic precursor 300A to give an at least a partially destrained curved primary polymer ceramic precursor 320, which is also referred to herein as a 4-D ceramic precursor.

The at least partially destraining can cause the 4-D ceramic precursor to have a four-dimensional shape, such as, for example, 4-D ceramic precursor 320, where programmable self-shaping can be implemented with the release of elastic energy stored present in, e.g., strained first and second primary polymeric ceramic precursors 300 and 300A. Other 4D shapes that can be achieved using the methods described herein include, as a result of the destraining, include a ribbon shape, a saddle shape, a zig-zag shape, mountain-valley designs, and Miura-ori designs. See FIGS. 3C-3E and Sci. Adv. 4: eaat0641 (2018) (DOI: 10.1126/sciadv.aat0641), which is incorporated by reference as if fully set forth herein. Miura-ori designs can be accessed, for example, by the additive manufacturing processes described herein, as shown in FIG. 3F. By starting at the primary polymer ceramic precursor depicted in FIG. 3F, near the (0,0) point, the various shapes shown in FIG. 3F can be accessed by varying the strain along the x- and y-axes. FIG. 3G shows how other 4D shapes can be accessed using the methods described herein, wherein a plurality of a plurality of third portions 306 are placed on first strained primary polymeric ceramic precursor 300 as shown, wherein each of the third portions is separated from an adjacent third portion 306 by a distance “d.” The examples provided in FIG. 3G, particularly the middle pattern, is an example of the third portion 306 being deposited at angles greater than 90° or less than 90°, relative to the first portion.

The third portion and the fourth portion described herein include a third composition and a fourth composition, respectively. The third composition and the fourth composition can have the same or different composition and dimensions, including aspect ratios, as at least one of the first composition 102 and the second composition 112.

The first composition 102 can have a first composition and the second composition 112 can have a second composition. In some instances, the first composition can be substantially the same as the second composition. For example, the first composition and second composition can be essentially the same with respect to each other, such that only a content of impurity materials present in small amounts (e.g., such as less than about 0.1) may constitute a difference between the first composition and the second composition. Alternatively, in another embodiment, the first composition and second composition, and the third composition and fourth composition for that matter, can be significantly different with respect to each other.

In at least one embodiment, the first, second, third, and fourth compositions can include a material such as an organic material, inorganic material, and a combination thereof. More particularly, the first, second, third, and fourth composition may include a ceramic, a glass, a metal, a polymer, or any combination thereof. In at least one embodiment, the first, second, third, and fourth composition can include a material such as an oxide, a carbide, a nitride, a boride, an oxycarbide, an oxynitride, an oxyboride, and any combination thereof. Notably, in one embodiment, the first, second, third, and fourth composition can include alumina or zirconia. More particularly, the first, second, third, and fourth composition can include an alumina-based material, such as a hydrated alumina material including, for example, boehmite.

The process of depositing the first, second, third, and fourth compositions can be conducted such that the first composition is deposited at a first time and the second composition is deposited at a second time and the first time and second time are discrete in different time intervals. In such embodiments, the deposition process can be an intermittent process, wherein the deposition process includes the formation of discrete portions during discrete durations of time. In an intermittent process, at least a portion of time passes between the formation of the first portion and the formation of the second portion, wherein there can be no deposition of material.

In another aspect of forming at least one of a primary polymeric ceramic precursor, first strained primary polymer ceramic precursor, second strained primary polymer ceramic precursor, and 4-D ceramic precursor via an additive manufacturing process, the process can be conducted according to a digital model. A digital model can include measuring at least a portion of the precursor and comparing it to a corresponding dimension of the digital model. The process of comparing can be conducted during the forming process or after the forming process is completed for a portion or the entire at least one of a primary polymeric ceramic precursor, first strained primary polymer ceramic precursor, second strained primary polymer ceramic precursor, and 4-D ceramic precursor. It will be appreciated that the provision of a digital model can facilitate the control of and the deposition process conducted by the deposition assembly 151.

In particular instances, the process of forming the at least one of a primary polymeric ceramic precursor, first strained primary polymer ceramic precursor, second strained primary polymer ceramic precursor, and 4-D ceramic precursor according to a digital model can further include creating a plurality of digital cross-sections of the digital model. Creation of the plurality of digital cross-sections can facilitate, for example, controlled deposition of one or more portions of the structure. For example, in one instance, the process can include depositing a first portion of the primary polymeric ceramic precursor at a first time, where the first portion corresponds to a first cross-section of a plurality of cross-sections of the digital model. Furthermore, the process can include depositing a second portion of the at least one of a primary polymeric ceramic precursor, first strained primary polymer ceramic precursor, second strained primary polymer ceramic precursor, and 4-D ceramic precursor distinct from the first portion at a second time that is different than the first time. The second portion can correspond to a second cross-section of the plurality of cross-sections of the digital model. Accordingly, it will be appreciated that the plurality of digital cross-sections can be a guide for depositing the plurality of discrete portions, where a single digital cross-section can facilitate the deposition of a discrete first portion and a second digital cross-section can facilitate the deposition of a second discrete portion. Each of the portions can be deposited, and while the deposition assembly 151 is depositing and forming each of the portions, the dimensions of the portions can be measured and compared to a digital model. More particularly, the deposition assembly 151 can be adapted to alter the deposition process based on the comparison of the dimensions of the deposited portion to a corresponding digital model portion.

It also will be appreciated that an additive manufacturing process can include a process of compiling discrete portions including, for example, the first portion 101 and second portion 110, to form a subsection 171. Furthermore, the process can include compiling a plurality of subsections to form the at least one of a primary polymeric ceramic precursor, first strained primary polymer ceramic precursor, second strained primary polymer ceramic precursor, and 4-D ceramic precursor.

The additive manufacturing process according to the embodiments herein also can be used to form a plurality of at least one of a primary polymeric ceramic precursor, first strained primary polymer ceramic precursor, second strained primary polymer ceramic precursor, and 4-D ceramic precursor, which can, in turn, be incorporated into abrasive articles described herein.

The additive manufacturing process forms at least one of a primary polymeric ceramic precursor, first strained primary polymer ceramic precursor, second strained primary polymer ceramic precursor, and 4-D ceramic precursor, which can be a green body or unfinished body that can undergo further processing to form a 4D-ceramic structure. Such further processing can include, but need not be limited to, drying, heating, volatilizing, sintering, curing, calcining, and a combination thereof.

Drying may include removal of a particular content of material, including volatiles, such as water or organic solvents. In accordance with an embodiment, the drying process can be conducted at a drying temperature of not greater than about 300° C., such as not greater than about 280° C., or even not greater than about 250° C. Still, in one non-limiting embodiment, the drying process can be conducted at a drying temperature of at least about 50° C. It will be appreciated that the drying temperature can be within a range between any of the minimum and maximum temperatures noted above. Furthermore, the drying process can be conducted for a particular duration. For example, the drying process can be not greater than about six hours.

The process of forming the at least one of a primary polymeric ceramic precursor, first strained primary polymer ceramic precursor, second strained primary polymer ceramic precursor, and 4-D ceramic precursor to a 4D-ceramic structure may further comprise a sintering process. Sintering of the at least one of a primary polymeric ceramic precursor, first strained primary polymer ceramic precursor, second strained primary polymer ceramic precursor, and 4-D ceramic precursor can be utilized to densify the article, which is generally in a green state. In a particular instance, the sintering process can facilitate the formation of a high-temperature phase of the ceramic material. For example, in one embodiment, the precursor primary polymeric ceramic precursor can be sintered such that a high-temperature phase of the material is formed, including for example, alpha alumina.

The process of forming the at least one of a primary polymeric ceramic precursor, first strained primary polymer ceramic precursor, second strained primary polymer ceramic precursor, and 4-D ceramic precursor to a 4D-ceramic structure can further comprise a process wherein the polymeric substrate is thermolytically removed by heating the 4-D ceramic precursor to provide a 4D-ceramic structure at a temperature of at least about 600° C., at least about 700° C., at least about 800° C., at least about 900° C., at least about 1000° C.; from about 600° C. to about 2000° C., about 800° C. to about 1500° C., about 900° C. to about 1200° C. or about 800° C. to about 1100° C. It will be appreciated that the thermolytic removal of the polymeric substrate can be performed at a temperature within a range between any of the minimum and maximum temperatures noted above. Furthermore, the thermolytic removal of the polymeric substrate can be conducted for a particular duration. For example, the thermolytic removal of the polymeric substrate can be not greater than about six hours. In addition, as shown in the flow diagrams in FIGS. 3A and 3B, the thermolytic removal of the polymeric substrate can be performed under an inert atmosphere (e.g., argon atmosphere) or under vacuum. The resulting (primary) 4-D ceramic structure can be subsequently heated in air to give a secondary 4-D ceramic structure having additional physical properties, including a different color than the primary 4-D ceramic structure.

In accordance with another aspect, a method of forming a fixed abrasive article including a 4D-ceramic structure formed through the additive manufacturing process described herein can also be accomplished. The fixed abrasive article may include a bonded abrasive article, a coated abrasive article, and the like, and can include abrasive segments. It will further be appreciated that the substrate can include, for example, a backing. In at least one embodiment, the forming process can be conducted such that a plurality of 4D-ceramic structures are deposited on, e.g., a make layer precursor, directly overlying the substrate (e.g., a backing). The make layer precursor can subsequently be at least partially cured to form a make layer. Alternatively, the ceramics can be combined with an inorganic material, a vitreous material, a crystalline material, an organic material, a resin material, a metal material, a metal alloy, and a combination thereof, to make a bonded abrasive article. The bonding layer can be a continuous layer or material or can be a discontinuous layer of material having discrete bonding regions separated by gaps, wherein essentially no bonding material is present.

Furthermore, it will be appreciated that such a process of forming a fixed abrasive article also can include orienting (e.g., vertical orientation, a rotational orientation, a flat orientation, or a side orientation) each of the a 4D-ceramic structure of the plurality of ceramics relative to each other as well as relative to a substrate 204.

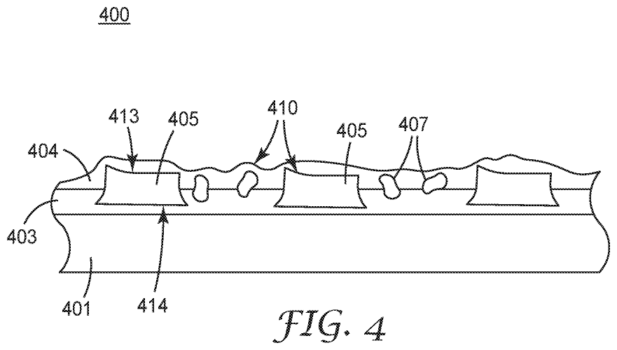

Turning briefly to FIG. 4, a coated abrasive article is illustrated including 4D-ceramic structures in a particular orientation relative to the substrate. For example, the coated abrasive article 400 can include a substrate 401 (e.g., a backing) and at least one adhesive layer overlying a surface of the substrate 401. The adhesive layer can include a make layer 403 and/or a size layer 404, which can be derived from at least partially curing a make layer precursor and a size layer precursor, respectively. The coated abrasive 400 can include abrasive particulate material 410, which can include 4D-ceramic structures 405 of the embodiments herein and optionally a second type of abrasive particulate material 407 in the form of diluent abrasive particles having a random shape, which may not necessarily be primary polymeric ceramic precursors. The make layer 403 can be overlying the surface of the substrate 401 and surrounding at least a portion of the 4D-ceramic structures 405 and second type of abrasive particulate material 407. The size layer 404 can be overlying and bonded to the 4D-ceramic structures 405 and second type of abrasive particulate material 407 and the make layer 403.

In some embodiments, the substrate of the fixed abrasive articles also can include a suitable additive or additives. For example, the substrate can include an additive chosen from the group consisting of catalysts, coupling agents, currants, anti-static agents, suspending agents, anti-loading agents, lubricants, wetting agents, dyes, fillers, viscosity modifiers, dispersants, defoamers, and grinding agents.

The adhesive layer can include a make layer. A polymer formulation can be used to form any of a variety of layers of the abrasive article such as, for example, a pre-size, the make layer, the size layer, and/or a supersize layer, which can be applied/disposed over at least a portion of the size layer. The polymer formulation can include a polymer resin, fibrillated fibers (e.g., in the form of pulp), filler material, and other optional additives. Suitable formulations include material such as a phenolic resin, wollastonite filler, defoamer, surfactant, a fibrillated fiber, and a balance of water. Suitable polymeric resin materials include curable resins selected from thermally curable resins including phenolic resins, urea/formaldehyde resins, phenolic/latex resins, as well as combinations of such resins. Other suitable polymeric resin materials may also include radiation curable resins, such as those resins curable using electron beam, UV radiation, or visible light, such as epoxy resins, acrylated oligomers of acrylated epoxy resins, polyester resins, acrylated urethanes and polyester acrylates and acrylated monomers including monoacrylated, multiacrylated monomers. The formulation can also comprise a nonreactive thermoplastic resin binder which can enhance the self-sharpening characteristics of the deposited abrasive composites by enhancing the erodability. Examples of such thermoplastic resin include polypropylene glycol, polyethylene glycol, and polyoxypropylene-polyoxyethene block copolymer, etc.

The adhesive layer also can include a size layer. The size layer can be overlying at least a portion of the plurality of 4D-ceramic structures described herein, as well as any second type of abrasive particulate material and the make layer. Like the make layer, the size layer can include a variety of suitable materials including, for example, an organic material, a polymeric material, or a material selected from the group consisting of polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and a combination thereof.

Coated abrasive articles have been described in detail herein, but it will be appreciated that the 4D-ceramic structures of the embodiments can be employed in bonded abrasive articles. Bonded abrasive articles can take various shapes including wheels, discs, cups, segments, and the like generally consisting of composites having abrasive grains contained within a three-dimensional bond matrix. Additionally, the bonded abrasive tools can include some volume percentage of porosity.

Examples of bonded abrasive articles include mounted point, a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel or a double disk grinding wheel.

Some suitable materials for use as the bond material can include metal materials, polymer materials (e.g., resin), vitreous or amorphous phase materials, crystalline phase materials, and a combination thereof.

Bonded abrasive articles are typically formed from an initial mixture including the bond material or a precursor of the bond material, the abrasive particles (e.g., primary polymeric ceramic precursors, diluent particles, combination of different types of abrasive particles, etc.), and fillers (e.g., active fillers, grinding aids, pore formers, mixing aids, reinforcing agents, etc.). The mixture can be formed into a green body (i.e., unfinished body) using various techniques, including but not limited to, molding, pressing, extruding, depositing, casting, infiltrating, and a combination thereof. The green body may undergo further processing to aid formation of the final-formed bonded abrasive body. The processing may depend on the composition of the mixture, but can include processes such as drying, curing, radiating, heating, crystallizing, re-crystallizing, sintering, pressing, decomposition, dissolution, and a combination thereof.

The final-formed bonded abrasive article can have various contents of the components (e.g., abrasive particles, bond material, filler, and porosity) depending on the intended end use. For example, in certain instances, the final-formed bonded abrasive article can have a porosity of at least about 5 vol. % of the total volume of the bonded abrasive article. In other embodiments, the porosity can be greater, such as on the order of at least about 15 vol. %, at least 25 vol. %, at least about 25 vol. %, at least about 50 vol. %, or even at least about 60 vol. %. Particular embodiments may utilize a range of porosity between about 5 vol. % and about 75 vol. % of the total volume of the bonded abrasive article.

Moreover, the final-formed bonded abrasive can have a content of bond material of at least about 10 vol. % for the total volume of the bonded abrasive body. In other instances, the body can include at least about 30 vol. %, such as at least about 40 vol. %, at least about 50 vol. % or even at least about 60 vol. % bond material for the total volume of the body of the bonded abrasive article. Certain embodiments may utilize a range of bond material between about 10 vol. % and about 90 vol. %, such as between about 10 vol. % and about 80 vol. %, or even between about 20 vol. % and about 70 vol. % of the total volume of the bonded abrasive article.

The final-formed bonded abrasive can have a content of abrasive particles of at least about 10 vol. % for the total volume of the bonded abrasive body. In other instances, the body can include at least about 30 vol. %, such as at least about 40 vol. %, at least about 50 vol. % or even at least about 60 vol. % abrasive particles for the total volume of the body of the bonded abrasive article. In other examples, the abrasive article may utilize a range of abrasive particles between about 10 vol. % and about 90 vol. %, such as between about 10 vol. % and about 80 vol. %, or even between about 20 vol. % and about 70 vol. % of the total volume of the bonded abrasive article.

This disclosure also contemplates nonwoven abrasive articles comprising abrasive particles comprising a microparticulate layer disposed on at least a portion of the outer surface of the abrasive particles, wherein the microparticulate layer comprises microparticles dispersed in a binder.

Briefly, FIG. 5 is a perspective view of a nonwoven abrasive article 1210. FIG. 6 is a sectional view of a nonwoven abrasive article of FIG. 5 taken along section line 12-12. As shown in FIGS. 5 and 6, the nonwoven abrasive article includes a nonwoven web 1212. The nonwoven web includes first major surface 1214 and opposite second major surface 1216. Each of the first major surface and the second major surface have an irregular or substantially non-planar profile. The nonwoven web includes fiber component 1218, which includes individual fibers 1220. Abrasive particles 1222, such as the 4D-ceramic structures described herein, which are dispersed throughout the nonwoven web and binder 1224 adheres the abrasive particles to the individual fibers.

While not so limited, the fiber component can range from about 5 wt. % to about 30 wt. % of the nonwoven abrasive article, about 10 wt. % to about 25 wt. %, about 10 wt. % to about 20 wt. %, about 12 wt. % to about 15 wt. %, less than, equal to, or greater than about 5 wt. %, 10, 15, 20, 25, or 30 wt. %. The fiber component can include a plurality of individual fibers that are randomly oriented and entangled with respect to each other. The individual fibers are bonded to each other at points of mutual contact. The individual fibers can be staple fibers or continuous fibers. As generally understood, “staple fiber” refers to a fiber of a discrete length and “continuous fiber” refers to a fiber that can be a synthetic filament. The individual fibers can range from about 70 wt. % to about 100 wt. % of the fiber component, about 80 wt. % to about 90 wt. %, less than, equal to, or greater than about 70 wt. %, 75, 80, 85, 90, 95, or 100 wt. % of the fiber component.

The individual staple fibers can have a length ranging from about 35 mm to 155 mm 50 mm to about 105 mm, about 70 mm to about 80 mm, less than, equal to, or greater than about 35 mm, 40, 45, 50, 55, 60, 65, 70, 75, 76, 80, 85, 90, 95, 100, 102, 105, 110, 115, 120, 125, 130, 135, 140, 145, 150, or 155 mm. A crimp index value of the individual staple fibers can range from about 15% to about 60%, about 25% to about 50%, less than, equal to, or greater than about 15%, 20, 25, 30, 35, 40, 45, 50, 55, or 60%. Crimp index is a measurement of a produced crimp; e.g., before appreciable crimp is induced in the fiber. The crimp index is expressed as the difference in length of the fiber in an extended state minus the length of the fiber in a relaxed (e.g., shortened) state divided by the length of the fiber in the extended state. The staple fibers can have a fineness or linear density ranging from about 200 denier to about 2000 denier, about 500 denier to about 600 denier, about 500 denier to about 700 denier, about 800 denier to about 1000 denier, about 900 denier to about 1000 denier, less than, equal to, or greater than about 200 denier, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000 denier.

In some examples, the fiber component can include a blend of staple fibers. For example, the fiber component can include a first plurality of individual fibers and a second plurality of individual staple fibers. The first and second pluralities of staple fibers of the blend can differ with respect to at least one of linear density value, crimp index, or length. For example, a linear density of the individual staple fibers of the first plurality of individual fibers can range from about 200 denier to about 700 denier, about 550 denier to about 650 denier, less than, equal to, or greater than about 200 denier, 250, 300, 350, 400, 450, 500, 550, 600, 650, or about 700 denier. A linear density of the individual staple fibers of the second plurality of individual fibers can range from about 800 denier to about 2000 denier, about 850 denier to about 1000 denier, less than, equal to, or greater than about 800 denier, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or 2000 denier. Blends of individual staple fibers with differing linear densities can be useful, for example, to provide an abrasive article that upon use can result in a desired surface finish. The length or crimp index of any of the individual fibers can be in accordance with the values discussed herein.

In examples of the abrasive article including blends of individual staple fibers the first and second pluralities of individual staple fibers can account for different portions of the fiber component. For example, the first plurality of individual fibers can range from about 20 wt. % to about 80 wt. % of the fiber component, about 30 wt. % to about 40 wt. %, less than, equal to, or greater than about 20 wt. %, 25, 30, 35, 40, 45, 50, 55, 60, 65, 70, 75, or 80 wt. %. The second plurality of individual fibers can range from about 20 wt. % to about 80 wt. % of the fiber component, about 60 wt. % to about 70 wt. %, less than, equal to, or greater than about 20 wt. %, 25, 30, 35, 40, 45, 50, 55, 60, 65, 70, 75, or 80 wt. %. While two pluralities of individual staple fibers are discussed herein, it is within the scope of this disclosure to include additional pluralities of individual staples fibers such as a third plurality of individual staple fibers that differs with respect to at least one of liner density value, crimp index, and/or length of the first and second pluralities of individual fibers.

The fibers of the nonwoven web can include many suitable materials. Factors influencing the choice of material include whether that material is suitably compatible with adhering binders and abrasive particles while also being processable in combination with other components of the abrasive article, and the material's ability to withstand processing conditions (e.g., temperatures) such as those employed during application and curing of the binder. The materials of the fibers can also be chosen to affect properties of the abrasive article such as, for example, flexibility, elasticity, durability or longevity, abrasiveness, and finishing properties. Examples of fibers that may be suitable include natural fibers, synthetic fibers, and mixtures of natural and/or synthetic fibers. Examples of synthetic fibers include those made from polyester (e.g., polyethylene terephthalate), nylon (e.g., nylon-6,6, polycaprolactam), polypropylene, acrylonitrile (e.g., acrylic), rayon, cellulose acetate, polyvinylidene chloride-vinyl chloride copolymer, and vinyl chloride-acrylonitrile copolymer. Examples of suitable natural fibers include cotton, wool, jute, and hemp. The fiber may be of virgin material or of recycled or waste material, for example, reclaimed from garment cuttings, carpet manufacturing, fiber manufacturing, or textile processing. The fiber may be homogenous or a composite such as a bicomponent fiber (e.g., a co-spun sheath-core fiber). The fibers can be tensilized and crimped staple fibers.

In some examples, the individual fibers can have a non-circular cross sectional shape or blends of individual fibers having a circular and a non-circular cross sectional shape (e.g., triangular, delta, H-shaped, tri-lobal, rectangular, square, dog bone, ribbon-shaped, or oval).

The abrasive article includes an abrasive component adhered to the individual fibers. The abrasive particles, such as the 4D-ceramic structures described herein, can range from about 5 wt. % to about 70 wt. % of the abrasive article, about 40 wt. % to about 60 wt. %, less than, equal to, or greater than about 5 wt. %, 10, 15, 20, 25, 30, 35, 40, 45, 50, 55, 60, 65, or 70 wt. %. The abrasive component can include individual abrasive particles, such as the 4D-ceramic structures described herein.

The term “about” as used herein can allow for a degree of variability in a value or range, for example, within 10%, within 5%, or within 1% of a stated value or of a stated limit of a range.

Unless specified otherwise herein, the term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Unless specified otherwise herein, the term “substantially no” as used herein refers to a minority of, or mostly no, as in less than about 10%, 5%, 2%, 1%, 0.5%, 0.01%, 0.001%, or less than about 0.0001% or less.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Select embodiments of the present disclosure include, but are not limited to, the following:

In a first embodiment, the disclosure provides an abrasive article comprising a plurality of 4D-ceramic structures, wherein the 4D-ceramic structures are made by a method comprising sequentially:

at least partially removing a strain from a second strained primary polymer ceramic precursor, comprising a polymeric substrate and ceramic precursor particles dispersed therein, to give a 4-D ceramic precursor comprising a polymeric substrate; and

thermolytically removing the polymeric substrate from the 4-D ceramic precursor comprising a polymeric substrate to provide a 4D-ceramic structure.

Embodiment 2 relates to the abrasive article of Embodiment 1, further comprising:

providing a primary polymeric ceramic precursor, comprising a polymeric substrate and ceramic precursor particles dispersed therein, the primary polymeric ceramic precursor comprising first and second portions;

straining the primary polymeric ceramic precursor to give the first strained primary polymer ceramic precursor comprising a polymeric substrate; and.

additively manufacturing at least one third portion on the first strained primary polymeric ceramic precursor to give the second strained primary polymer ceramic precursor comprising a polymeric substrate.

Embodiment 3 relates to the abrasive article of Embodiment 2, further comprising:

forming the primary polymeric ceramic precursor, the primary polymeric ceramic precursor comprising first and second portions.

Embodiment 4 relates to the abrasive article of Embodiments 1-3, wherein the strain in an x-axis is substantially the same as the straining in a y-axis.

Embodiment 5 relates to the abrasive article of Embodiments 1-3, wherein the strain in an x-axis is different than the straining in a y-axis.

Embodiment 6 relates to the abrasive article of Embodiments 1-5, wherein the at least partially removing a strain causes the second strained primary polymer ceramic precursor to change shape to have a four-dimensional shape.

Embodiment 7 relates to the abrasive article of Embodiment 6, wherein the four-dimensional shape is at least one of a curved shape, a ribbon shape, a saddle shape, a zig-zag shape, a mountain-valley design, and a Miura-orig design shape.

Embodiment 8 relates to the abrasive article of Embodiment 1-7, wherein the ceramic precursor particles are ceramic precursor nanoparticles.

Embodiment 9 relates to the abrasive article of Embodiment 1-8, wherein the ceramic precursor particles comprise alumina, alumina zirconia, or zirconia.

Embodiment 10 relates to the abrasive article of Embodiments 1-9, wherein the ceramic precursor particles comprise nitrides or carbides.

Embodiment 11 relates to the abrasive article of Embodiments 1-10, wherein the thermolytically removing the polymeric substrate is performed at a temperature of at least about 600° C.

Embodiment 12 relates to the abrasive article of Embodiment 1, further comprising disposing the 4D-ceramic structure into an inorganic material, a vitreous material, a crystalline material, an organic material, a resin material, a metal material, a metal alloy, or a combination thereof.

Embodiment 13 relates to the abrasive article of Embodiment 1-2, further comprising disposing the 4D-ceramic structure on a non-woven web.

Embodiment 14 relates to the abrasive article of Embodiment 1-2, further comprising disposing the 4D-ceramic structure onto a make layer precursor of a backing.

Embodiment 15 relates to the abrasive article of Embodiment 14, further comprising at least partially curing the make layer precursor to provide a make layer.

Embodiment 16 relates to the abrasive article of Embodiment 15, further comprising:

disposing a size layer precursor over at least a portion of the make layer; and at least partially curing the size layer precursor layer to provide a size layer.

Embodiment 17 relates to the abrasive article of Embodiment 16, further comprising applying a supersize layer over at least a portion of the size layer.

Embodiment 18 relates to the abrasive article of Embodiment 1, wherein the abrasive article is a coated abrasive article, a non-woven abrasive article or a bonded abrasive article.

Embodiment 19 relates to the abrasive article of Embodiment 18, wherein the bonded abrasive article is a mounted point, a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel, a double disk grinding wheel, and abrasive segments.

It will be apparent to those skilled in the art that the specific structures, features, details, configurations, etc., that are disclosed herein are simply examples that can be modified and/or combined in numerous embodiments. All such variations and combinations are contemplated by the inventor as being within the bounds of this disclosure. Thus, the scope of the disclosure should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control. Furthermore, all publications, patents, and patent documents referred to in this document are incorporated by reference herein in their entirety, as though they were fully set forth herein.

1. An abrasive article comprising a plurality of 4D-ceramic structures, wherein the 4D-ceramic structures are made by a method comprising sequentially:
at least partially removing a strain from a second strained primary polymer ceramic precursor, comprising a polymeric substrate and ceramic precursor particles dispersed therein, to give a 4-D ceramic precursor comprising a polymeric substrate; and
thermolytically removing the polymeric substrate from the 4-D ceramic precursor comprising a polymeric substrate to provide a 4D-ceramic structure.

2. The abrasive article of claim 1, further comprising:
providing a primary polymeric ceramic precursor, comprising a polymeric substrate and ceramic precursor particles dispersed therein, the primary polymeric ceramic precursor comprising first and second portions;
straining the primary polymeric ceramic precursor to give the first strained primary polymer ceramic precursor comprising a polymeric substrate; and.
additively manufacturing at least one third portion on the first strained primary polymeric ceramic precursor to give the second strained primary polymer ceramic precursor comprising a polymeric substrate.

3. The abrasive article of claim 2, further comprising:
forming the primary polymeric ceramic precursor, the primary polymeric ceramic precursor comprising first and second portions.

4. The abrasive article of claim 1, wherein the strain in an x-axis is substantially the same as the straining in a y-axis.

5. The abrasive article of claim 1, wherein the strain in an x-axis is different than the straining in a y-axis.

6. The abrasive article of claim 1, wherein the at least partially removing a strain causes the second strained primary polymer ceramic precursor to change shape to have a four-dimensional shape.

7. The abrasive article of claim 6, wherein the four-dimensional shape is at least one of a curved shape, a ribbon shape, a saddle shape, a zig-zag shape, a mountain-valley design, and a Miura-orig design shape.

8. The abrasive article of claim 1, wherein the ceramic precursor particles are ceramic precursor nanoparticles.

9. The abrasive article of claim 1, wherein the ceramic precursor particles comprise alumina, alumina zirconia, or zirconia.

10. The abrasive article of claim 1, wherein the ceramic precursor particles comprise nitrides or carbides.

11. The abrasive article of claim 1, wherein the thermolytically removing the polymeric substrate is performed at a temperature of at least about 600° C.

12. The abrasive article of claim 1, further comprising disposing the 4D-ceramic structure into an inorganic material, a vitreous material, a crystalline material, an organic material, a resin material, a metal material, a metal alloy, or a combination thereof.

13. The abrasive article of claim 1, further comprising disposing the 4D-ceramic structure on a non-woven web.

14. The abrasive article of claim 1, further comprising disposing the 4D-ceramic structure onto a make layer precursor of a backing.

15. The abrasive article of claim 14, further comprising at least partially curing the make layer precursor to provide a make layer.

16. The abrasive article of claim 15, further comprising:
disposing a size layer precursor over at least a portion of the make layer; and
at least partially curing the size layer precursor layer to provide a size layer.

17. The abrasive article of claim 16, further comprising applying a supersize layer over at least a portion of the size layer.

18. The abrasive article of claim 1, wherein the abrasive article is a coated abrasive article, a non-woven abrasive article or a bonded abrasive article.

19. The abrasive article of claim 18, wherein the bonded abrasive article is a mounted point, a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel, a double disk grinding wheel, and abrasive segments.
